(19) United States
(12) Patent Application Publication
(10) Pub. No.: US 2012/0040239 A1
(43) Pub. Date: Feb. 16, 2012

(54) SEALING CONSTRUCTION FOR SECONDARY CELL

(76) Inventors: Kazutoshi TAKAHASHI, Mito-shi (JP); Hayato Koguchi, Hitachinaka-shi (JP); Koji Higashimoto, Fukaya-shi (JP)

(21) Appl. No.: 13/205,892

(22) Filed: Aug. 9, 2011

(30) Foreign Application Priority Data
Aug. 10, 2010 (JP) 2010-179451

(51) Int. Cl. H01M 2/08; H01M 10/00

(52) U.S. Cl. 429/174; 429/181

(57) ABSTRACT

The present invention is a sealing construction for a secondary cell in which an electrode terminal member is disposed inside an opening of a cell container with interposition of a seal member, with a circumferential portion of the cell container around its opening being bent inwards together with the seal member and the cell container and the electrode terminal member being swaged together, wherein: on outer surface of the cell container, between a bent portion where the cell container is bent and the opening, an edged summit portion and a protruding portion having a sloping portion that ranges from an edge portion facing the opening of the cell container to the summit portion are formed in an annular shape around circumferential direction of the opening of the cell container.

### INCORPORATION BY REFERENCE

The disclosure of the following priority application is herein incorporated by reference: Japanese Patent Application No. 2010-179451 filed Aug. 10, 2010.

### BACKGROUND OF THE INVENTION

1. Field of the Invention

The present invention relates to a sealing construction for a secondary cell.

2. Description of Related Art

In a cylindrical secondary cell, of which a lithium secondary cell is representative, an electrode group in which a positive electrode and a negative electrode are wound together with the interposition of separators and so on constitutes an electricity generation element, this electricity generation element is received in a cell container, and a lid member is swaged upon the cell container, thus sealing it. The cell container is shaped as a cylinder having a bottom but no top, and the lid member has a hat-like shape, being shaped as a small cylinder with a top but no bottom and having a flat external peripheral flange portion. Both the cell container and the lid member are processed by electroplating over the entirety of both their outer and inner surfaces. In the formation of the sealing construction, normally a swaging method is employed, in which the cell container and the lid member are swaged together with the interposition of a seal member made from rubber or synthetic resin, i.e. a so-called gasket, that is fitted into the opening at the upper end of the cell container.

The sealing construction is formed by bending the peripheral portion at the top of the cell container surrounding its opening almost through a right angle with respect to the axial direction of the cell container, and by thus compressing the seal member between this peripheral portion of the cell container and the external peripheral flange portion of the lid member. When the cell container is thus bent almost through a right angle, this bending processing is performed by contacting a press die against the edge portion of the opening of the cell container. In order to ensure that this sealing construction is proof against high pressure from the interior, a construction is per se known (refer to Japanese Patent 4,223,134) by which the edge portion of the opening of the cell container is squeezed in a downwards direction of 5° to 30° with respect to the horizontal.

### SUMMARY OF THE INVENTION

An almost right angled corner portion is present at the end of the main circumferential surface of the cell container, that constitutes the edge of the portion bordering upon its upper opening. When electroplating is being performed upon the cell container, since the current density at this corner portion of its external surface is greater than at the other surface portions thereof, accordingly the thickness of the plated layer in the vicinity of this corner portion becomes greater than at those other surface portions. And since a large pressure is applied when bending the cell container, there is a possibility that detachment of a portion of this plated layer that has been formed rather thickly may take place. Moreover, when performing the bending processing while contacting the press die against the edge portion of the cell container around its opening, since the side of edge portion that faces the opening of the cell container has actually a plane form, the portion where it contacts against the press die is not uniform, and the shape into which this curved portion is bent may become non-uniform. This can cause increase of the internal stresses within the plated layer, and may engender detachment of the plated layer.

According to the 1st aspect of the present invention, a sealing construction for a secondary cell in which an electrode terminal member is disposed inside an opening of a cell container with interposition of a seal member, with a circumferential portion of the cell container around its opening being bent inwards together with the seal member and the cell container and the electrode terminal member being swaged together, wherein: on outer surface of the cell container, between a bent portion where the cell container is bent and the opening, a protruding portion having an edged summit portion and having a sloping portion that ranges from an edge portion facing the opening of the cell container to the summit portion is formed in an annular shape around circumferential direction of the opening of the cell container.

According to the 2nd aspect of the present invention, in a sealing construction for a secondary cell according to the 1st aspect, it is preferred that a plated layer is formed on the outer surface and on the inner surface of the cell container, including the protruding portion.

According to the 3rd aspect of the present invention, in a sealing construction for a secondary cell according to the 1st aspect, it is preferred that the summit portion of the protruding portion of the cell container has a height of 0.05 mm or greater.

According to the 4th aspect of the present invention, in a sealing construction for a secondary cell according to the 1st aspect, it is preferred that the sloping portion of the protruding portion of the cell container has an angle of slope, rising from the direction orthogonal to the axis of the cell container, of 5° or greater with respect to the axis of the cell container.

According to the 5th aspect of the present invention, in a sealing construction for a secondary cell according to the 1st aspect, it is preferred that the cell container, including the protruding portion, is entirely made by sheet metal processing from a sheet of a metal selected from any one of ferrous metal, aluminum, or stainless steel.

According to the 6th aspect of the present invention, in a sealing construction for a secondary cell according the 1st aspect, it is preferred that the secondary cell has a cylindrical shape, and the protruding portion has a shape of a circular annulus in planar view.

According to the 7th aspect of the present invention, in a sealing construction for a secondary cell according to the 2nd aspect, it is preferred that the summit portion of the protruding portion of the cell container has a height of 0.05 mm or greater.

According to the 8th aspect of the present invention, in a sealing construction for a secondary cell according to the 2nd aspect, it is preferred that the sloping portion of the protruding portion of the cell container has an angle of slope, rising from the direction orthogonal to the axis of the cell container, of 5° or greater with respect to the axis of the cell container.

According to the 9th aspect of the present invention, in a sealing construction for a secondary cell according to the 2nd aspect, it is preferred that the cell container, including the protruding portion, is entirely made by sheet metal processing from a sheet of a metal selected from any one of ferrous metal, aluminum, or stainless steel.

According to the 10th aspect of the present invention, in a sealing construction for a secondary cell according to the 2nd aspect, it is preferred that the secondary cell has a cylindrical shape, and the protruding portion has a shape of a circular annulus in planar view.

According to the 11th aspect of the present invention, a secondary cell including the sealing construction for a secondary cell according to the 1st aspect.

### BRIEF DESCRIPTION OF THE DRAWINGS

FIG. 1 is a sectional view of a cylindrical secondary cell to which an embodiment of the sealing construction for a secondary cell of the present invention has been applied;

FIG. 2 is an exploded perspective view of the cylindrical secondary cell shown in FIG. 1;

FIG. 3 is a perspective view of an electrode group of FIG. 1, showing it in a partly cut away state so that its details are visible;

FIG. 4 is an enlarged sectional view of a portion A of the cell container shown in FIG. 1;

FIG. 5 is a perspective view for explanation of a first process performed during manufacture of the cell container shown in FIG. 1, showing the starting form of material which will be processed to a cell container;

FIG. 6 is a perspective view of the material deformed in a process performed subsequent to the process of FIG. 5;

FIG. 7 is a perspective view of the material deformed in further process following the process of FIG. 6;

FIG. 8 is an enlarged sectional view of a portion indicated with “B” in FIG. 7, for explanation of a process performed subsequent to the process of FIG. 7;

FIG. 9 is a sectional view of the entire cell container, showing its state when the process shown in FIG. 8 has been completed;

FIG. 10 is a sectional view of a corner portion of the cell container, for explanation of a process performed subsequent to the stage of FIG. 9;

FIG. 11 is a similar sectional view for explanation of a process performed subsequent to the process of FIG. 10; and

FIG. 12 is a similar sectional view for explanation of a process performed subsequent to the process of FIG. 11.

### DESCRIPTION OF THE PREFERRED EMBODIMENT

### Overall Structure of the Secondary Cell

In the following, the sealing construction for a secondary cell of this invention will be explained with reference to an embodiment in which this construction is applied to a cylindrical lithium ion secondary cell, and with reference to the drawings.

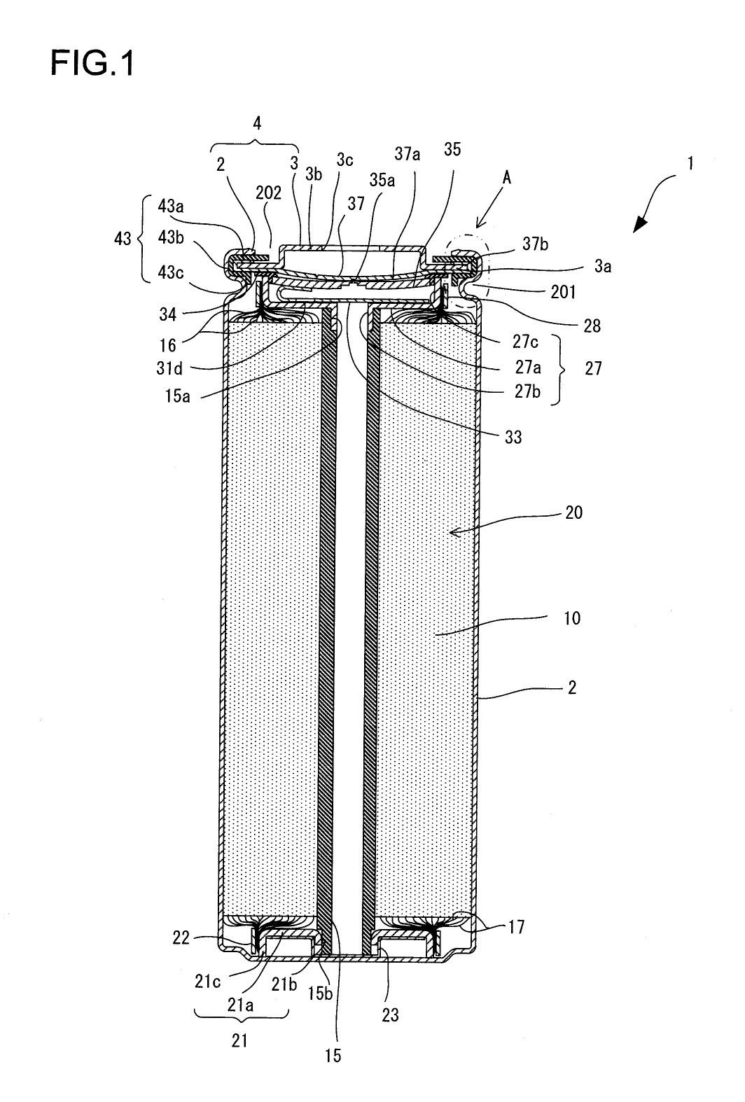

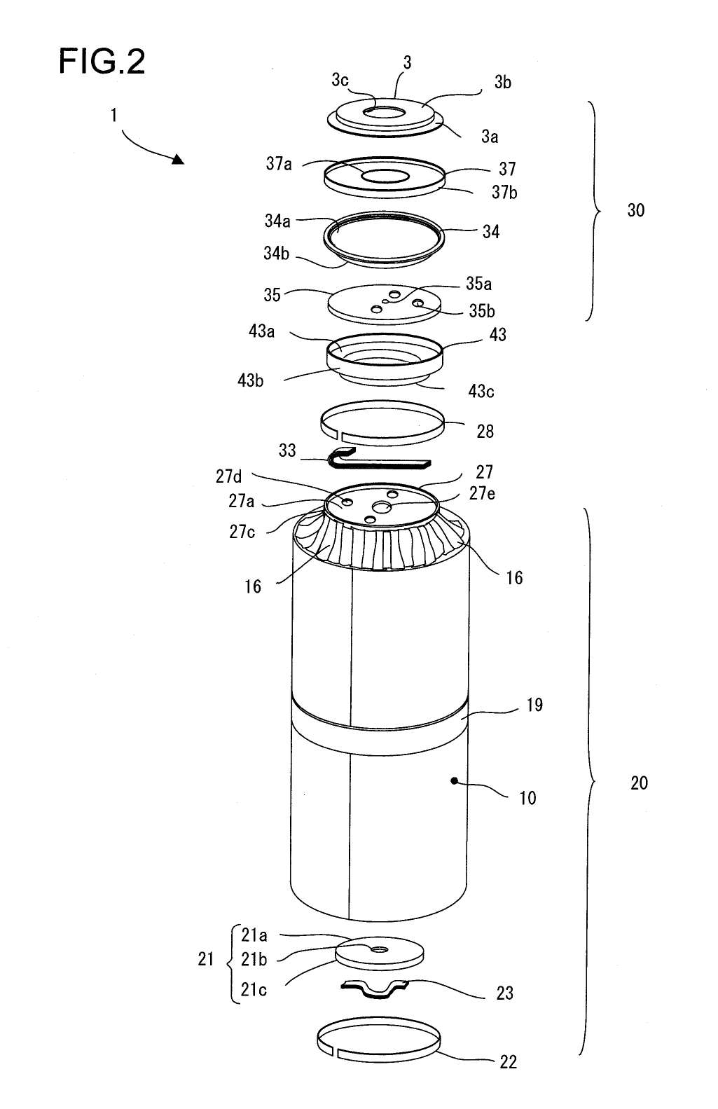

FIG. 1 is a vertical sectional view showing an embodiment of the cylindrical secondary cell of the present invention, and FIG. 2 is an exploded perspective view of the cylindrical secondary cell shown in FIG. 1.

The cylindrical secondary cell 1, for example, may be shaped as a cylinder that has an external shape of diameter 40 mm and a height of 100 mm.

This cylindrical secondary cell 1 includes a cylindrical cell container 2 having a bottom, and a hat shaped lid member 3 (i.e. an electrode terminal member), and normally the cell container 2 is provided with a sealing construction 4 that seals its interior from its exterior, and that is implemented by performing a swaging process upon the container 2 and the lid member 3 with a seal member 43, or so-called gasket, being interposed between them. The cylindrical cell container 2 with a bottom is made by press processing from metal plate such as a ferrous metal, aluminum, stainless steel or the like, and, in the case of a ferrous metal, for corrosion protection, a plated layer of nickel or the like is deposited over its entire exterior surface and over its entire interior surface. This cell container has an opening 202 at its upper end portion, i.e. at its open end portion. A groove 201 is formed upon the wall of the cell container 2 at an axial location near the opening 202, so as to project inwards. And various structural members for the generation of electricity are held in the interior of the cell container 2, as will now be described.

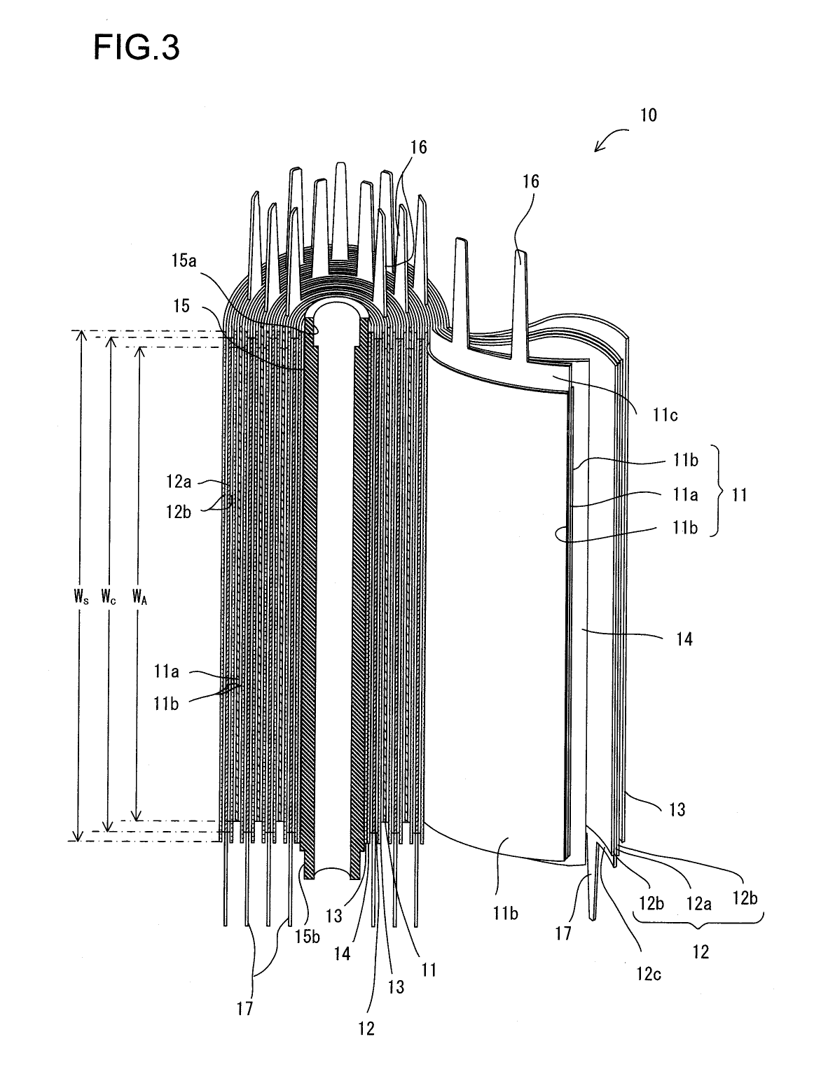

The reference symbol 10 denotes an electrode group that has a winding core 15 at its center, and a positive electrode and a negative electrode are wound around this winding core 15. FIG. 3 shows the detailed construction of the electrode group 10, and is a perspective view showing the electrode group 10 in a state with a portion thereof cut away. As shown in FIG. 3, this electrode group 10 has a structure in which a positive electrode 11, a negative electrode 12, and first and second separators 13 and 14 are wound around the outside of the winding core 15.

The winding core 15 is formed as a hollow cylinder, around which the first separator 13, the negative electrode 12, the second separator 14, and the positive electrode 11 are laminated in that order, and are wound up. And, inside the innermost winding of the negative electrode 12, the first separator 13 and the second separator 14 are wound a certain number of times (in FIG. 3, once). Furthermore, the negative electrode 12 appears on the outside, with the first separator 13 being wound around it. And finally, on the outside, the first separator 13 is held down with adhesive tape 19 (refer to FIG. 2).

The positive electrode 11 is made from aluminum foil and has an elongated shape, and includes a positive electrode sheet 11a and a processed positive electrode portion in which a positive electrode mixture is applied to form a layer 11b on both sides of this positive electrode sheet 11a. The upper side edge of the positive electrode sheet 11a along its longitudinal direction, to both sides of which the positive electrode mixture is not applied and along which the aluminum foil is accordingly exposed, constitutes a positive electrode mixture untreated portion 11c that is not treated with the positive electrode mixture. A large number of positive leads 16 are formed integrally at regular intervals upon this positive electrode mixture untreated portion 11c, in the form of tags that project upwards parallel to the winding core 15.

The positive electrode mixture consists of an active positive electrode material, an electrically conductive positive electrode material, and a positive electrode binder. The active positive electrode material is desirably a lithium metal oxide or a lithium transitional metal oxide. For example, lithium cobalt oxide, lithium manganate, lithium nickel oxide, or a compound lithium metal oxide (that includes two or more sorts of lithium metal oxides selected from the lithium metal oxides based on cobalt, nickel, and manganese) may be suggested. The electrically conductive positive electrode material is not particularly limited, provided that it is a substance that can assist transmission to the positive electrode of electrons that are generated in the positive electrode mixture by a lithium occlusion/emission reaction. As examples of a material for this electrically conductive positive electrode mixture, graphite or acetylene black or the like may be suggested. It should be noted that the above mentioned compound lithium metal oxide including transitional metal components may also itself be used as a conductive positive electrode material, since it has electrical conductivity.

The positive electrode binder holds together the active positive electrode material and the electrically conductive positive electrode material, and also is capable of adhering together the layer of positive electrode mixture 11b and the positive electrode sheet 11a, and is not particularly limited, provide that it is not greatly deteriorated by contact with the non-aqueous electrolyte. As an example of a material for this positive electrode binder, polyvinylidene fluoride (PVDF) or fluorine-containing rubber or the like may be suggested. The method of making the positive electrode mixture layer 11b is not particularly limited, provided that it is a method of forming the layer 11b of positive electrode mixture upon the positive electrode. As an example of a method for making the positive electrode mixture 11b in the form of a layer, the method may be suggested of applying, onto the positive electrode sheet 11a, a solution in which the substances that make up the positive electrode mixture are dispersed.

As a method for applying the positive electrode mixture to the positive electrode sheet 11a, a roll coating method, a slit die coating method or the like may be suggested. As a solvent for the solution in which the positive electrode mixture is to be dispersed, for example, it may be added to N-methylpyrrolidone (NMP) or water or the like and kneaded into a slurry, that is then applied uniformly to both sides of an aluminum foil of thickness, for example, 20 μm; and, after drying, this may be cut up by stamping. The positive electrode mixture may be applied, for example, to a thickness of around 40 μm on each side. When the positive electrode sheet 11a is cut out by stamping, the positive leads 16 are formed integrally therewith at the same time. The lengths of all of the positive leads 16 are almost the same.

The negative electrode 12 is made from copper foil and has an elongated shape, and includes a negative electrode sheet 12a and a processed negative electrode portion in which a negative electrode mixture is applied to form a layer 12b on both sides of this negative electrode sheet 12a. Both sides of the lower side edge of the negative electrode sheet 12a along the longitudinal direction, to which the negative electrode mixture is not applied and along which the copper foil is accordingly exposed, constitute a negative electrode mixture untreated portion 12c that is not treated with the negative electrode mixture. A large number of negative leads 17, which project downwards, i.e. in the direction opposite to the direction in which the positive leads 16 project, are formed integrally at regular intervals upon this negative electrode mixture untreated portion 12c. With this construction, it is possible to disperse the flow of electrical current approximately equally, and this fact conduces to enhancement of the reliability of this lithium ion secondary cell.

The negative electrode mixture consists of an active negative electrode material, a negative electrode binder, and a thickener. This negative electrode mixture may also include an electrically conductive negative electrode material such as acetylene black or the like. It is desirable to use graphitic carbon as the active negative electrode material, and in particular, it is desirable to use synthetic graphite. By using graphitic carbon, it is possible to manufacture a lithium ion secondary cell that is suitable for a plug-in hybrid vehicle or electric vehicle, for which high capacity is demanded. The method for forming a layer of the negative electrode mixture 12b is not particularly limited, provided that it is a method that can form a layer of the negative electrode mixture 12b upon the negative electrode sheet 12a. As a method for applying the negative electrode mixture to the negative electrode sheet 12a, for example, the method may be suggested of applying upon the negative electrode sheet 12a a solution in which the constituent substances of the negative electrode mixture are dispersed. As the method for application, for example, a roll coating method, a slit die coating method or the like may be suggested.

As a method for applying the negative electrode mixture to the negative electrode sheet 12a, for example, N-methyl-2-pyrrolidone or water may be added to the negative electrode mixture as a dispersal solvent and kneaded into a slurry, that is then applied uniformly to both sides of a rolled copper foil of thickness, for example, 10 μm; and, after drying, this may be cut up. The negative electrode mixture may be applied, for example, to a thickness of around 40 μm on each side. When the negative electrode sheet 12a is cut out, the negative leads 17 are formed integrally therewith at the same time. The lengths of all of the negative leads 17 are almost the same.

The width W_{S} of the first separator 13 and of the second separator 14 is formed to be greater than the width W_{C} of the layer of negative electrode mixture 12b that is formed upon the negative electrode sheet 12a. Moreover, the width W_{C} of the layer of negative electrode mixture 12b that is formed upon the negative electrode sheet 12a is formed to be greater than the width W_{A} of the positive electrode mixture layer 11b that is formed upon the positive electrode sheet 11a.

By making the width W_{C} of the layer of negative electrode mixture 12b greater than the width W_{A} of the layer of positive electrode mixture 11b, internal short circuiting due to the deposition of foreign matter is prevented. This is done because, in the case of a lithium ion secondary cell, while the lithium that is the active positive electrode material is ionized and permeates the separator, if there is some portion on the negative electrode sheet 12a upon which the layer of active negative electrode material 12b is not formed so that the negative electrode sheet 12a is exposed to the layer of positive electrode material 11b, then the lithium therein will be deposited upon the negative electrode sheet 12a, and this can cause an internal short circuit to occur. The first and second separators 13 and 14 may, for example, be made from perforated polyethylene film of 40 μm thickness.

Referring to FIGS. 1 and 3, a stepped portion 15a with a diameter larger than the inner diameter of the remainder of the winding core 15 is formed on the inner surface of the hollow cylindrical shaped winding core 15 at its upper end portion in the axial direction (the vertical direction in the drawing), and a positive electrode current collecting member 27 is pressed into this stepped portion 15a.

This positive electrode current collecting member 27 may, for example, be made from aluminum, and includes a circular disk shaped base portion 27a, a lower cylinder portion 27b that projects to face towards the winding core 15 at the surface of this base portion 27a facing the electrode group 10 and that is pressed into the inner surface of the stepped portion 15a, and an upper cylindrical portion 27c at the outer peripheral edge that projects upwards and outwards towards the lid member 3. Apertures 27d (refer to FIG. 2) are formed in the base portion 27a of the positive electrode current collecting member 27, for allowing the escape of gas generated in the interior of the cell. Furthermore, an aperture 27e (refer to FIG. 2) is formed in the base portion 27a of the positive electrode current collecting member 27; the function of this aperture 27e will be described hereinafter. It should be noted that the winding core 15 is made of a material of a type that isolates electrically between the positive electrode current collecting member 27 and the negative electrode current collecting member 21, and that also maintains and enhances the axial rigidity of the cell. In the present embodiment, for example, a polypropylene is employed as the material for the winding core 15.

All of the positive leads 16 of the positive electrode sheet 11a are welded to the upper cylindrical portion 27c of the positive electrode current collecting member 27. In this case, as shown in FIG. 2, the positive leads 16 are overlapped over one another and joined upon the upper cylindrical portion 27c of the positive electrode current collecting member 27. Since each of these positive leads 16 is very thin, accordingly it is not possible for a large electrical current to be taken out by just one of them. Due to this, the large number of positive leads 16 are formed at predetermined intervals over the total length of the upper edge of the positive electrode sheet 11a from the start of its winding onto the winding core 15 to the end of that winding.

Since the positive electrode current collecting member 27 is oxidized by the electrolyte, its reliability can be enhanced by making it from aluminum. When the aluminum on the front surface is exposed by any type of processing, immediately a coating of aluminum oxide is formed upon that front surface, so that it is possible for oxidization by the electrolyte to be prevented due to this layer of aluminum oxide.

Moreover, by making the positive electrode current collecting member 27 from aluminum, it becomes possible to weld the positive leads 16 of the positive electrode sheet 11a thereto by ultrasonic welding or spot welding or the like.

The positive leads 16 of the positive electrode sheet 11a and an annular pressure member 28 are welded to the external periphery of the upper cylindrical portion 27c of the positive electrode current collecting member 27. The large number of positive leads 16 are closely clamped against the external peripheral surface of the upper cylindrical portion 27c of the positive electrode current collecting member 27, the pressure member 28 is fitted over the externally oriented surfaces of the positive leads 16 and temporarily held there, and then they are all welded together in that state.

A stepped portion 15b whose outer diameter is smaller than the outer diameter of the winding core 15 is formed upon the external peripheral surface of the lower end portion of the winding core 15, and a negative electrode current collecting member 21 is pressed over this stepped portion 15b and thereby fixed thereto. This negative electrode current collecting member 21 may, for example, be made from copper, and is formed with a circular disk shaped portion 21a and with an opening portion 21b that is formed in the disk shaped portion 21a and is pressed over the stepped portion 15b of the winding core 15; and, on its outer peripheral edge, an external circumferential cylinder portion 21c is formed so as to project facing downwards towards the bottom portion of the cell container 2.

All of the negative leads 17 of the negative electrode sheet 12a are welded to the external circumferential cylinder portion 21c of the negative electrode current collecting member 21 by ultrasonic welding or the like. Since each of these negative leads 17 is very thin, in order to take out a large electrical current, a large number of them are formed over the total length of the lower edge of the negative electrode sheet 12a from the start of its winding onto the winding core 15 to the end of its winding, at predetermined intervals.

The negative leads 17 of the negative electrode sheet 12a and an annular pressure member 22 are welded to the external periphery of the external circumferential cylinder portion 21c of the negative electrode current collecting member 21. The large number of negative leads 17 are closely clamped against the external peripheral surface of the external circumferential cylinder portion 21c of the negative electrode current collecting member 21, the pressure member 22 is fitted over the externally oriented surfaces of the negative leads 17 and temporarily held there, and then they are all welded together in that state.

A negative electrode power lead 23 that is made from copper is welded to the lower surface of the negative electrode current collecting member 21. This negative electrode power lead 23 is also welded to the bottom portion of the cell container 2. The cell container 2 may, for example, be made from carbon steel of thickness 0.5 mm, and its surface is processed by nickel plating. By using this type of material, it is possible to weld the negative electrode power lead 23 to the cell container 2 by resistance welding or the like.

The aperture 27e that is formed in the positive electrode current collecting member 27 is for insertion of an electrode rod (not shown in the drawings) for welding the negative electrode power lead 23 to the bottom of the cell container 2. In more detail, a welding electrode rod is inserted through the aperture 27e formed in the positive electrode current collecting member 27 into and through the hollow central axis of the winding core 15, and its tip end portion presses the negative electrode power lead 23 against the inner surface of the bottom portion of the cell container 2, so that it can be welded by resistance welding. The negative electrode current collecting member 21 and the cell container 2 to which it is thus connected operate as one output terminal, so that it is possible to take out the electrical power accumulated in the electrode group 10 from the cell container 2.

As explained above, by the large number of positive leads 16 being welded to the positive electrode current collecting member 27 and the large number of negative leads 17 being welded to the negative electrode current collecting member 21, the positive electrode current collecting member 27, the negative electrode current collecting member 21, and the electrode group 10 are integrated together into the generating unit 20 (refer to FIG. 2). However in FIG. 2, for the convenience of illustration, the negative electrode current collecting member 21, the pressure member 22, and the negative electrode power lead 23 are shown as separated from the generating unit 20.

Furthermore, the one end portion of a flexible connecting member 33 that is made by laminating together a plurality of layers of aluminum foil is joined to the upper surface of the base portion 27a of the positive electrode current collecting member 27 by welding. Since this connecting member 33 is made by laminating together and integrating a plurality of layers of aluminum foil, accordingly it is capable of carrying a large electrical current, and moreover it is endowed with flexibility. In other words, while it is necessary to make the overall thickness of the connection member great in order for it to conduct a high electrical current, if it were to be made from a single metallic plate, its rigidity would become high, and it would lose its flexibility. Accordingly this connection member 33 is made by laminating together a large number of aluminum foils, so that its flexibility is preserved. The thickness of the connection member 33 may, for example, be 0.5 mm, and it may be made by laminating together 5 sheets of aluminum foil each of thickness 0.1 mm.

An annular insulation ring 34 that is made from an insulating resin material and that has a circular opening portion 34a is mounted over the upper cylindrical portion 27c of the positive electrode current collecting member 27. This insulation ring 34 has the opening portion 34a (refer to FIG. 2) and an annular ring portion 34b that projects downwards. A connection plate 35 is fitted into the opening portion 34a of the insulation ring 34. The other end of the flexible connection member 33 is attached to the lower surface of this connection plate 35 by welding.

The connection plate 35 is made from aluminum alloy, and is almost uniform all over except for its central portion; however, its central portion is sagging downwards slightly into a lower position, so that it has a dished shape. The thickness of this connection plate 35 may be, for example, around 1 mm. A projecting portion 35a that is made in a shallow dome shape is formed at the center of the connection plate 35, and a plurality of apertures 35b (refer to FIG. 2) are formed around the projecting portion 35a. These apertures 35b have the function of allowing escape of gas generated in the interior of the cell.

This projecting portion 35a of the connecting plate 35 is joined to the central portion of the bottom surface of a diaphragm 37 by resistance welding or friction stir welding. This diaphragm 37 is made from aluminum alloy, and a circular groove 37a is provided around the central portion of the diaphragm 37. The groove 37a is made by squashing the upper surface of the diaphragm 37 into a letter-V shape by pressing with a die, so that the portion remaining is very thin.

The diaphragm 37 is provided in order to ensure the safety of the cell: if the pressure internal to the cell rises, then at a first stage this diaphragm 37 bends somewhat upwards, and its junction to the projecting portion 35a of the connection plate 35 becomes detached so that it separates from the connection plate 35, so that its electrical continuity with the connection plate 35 is broken. If the pressure internal to the cell still continues to rise, then at a second stage the groove 37a ruptures, and this functions to vent the gas internal to the cell and reduce the internal pressure.

At its peripheral portion, the diaphragm 37 is fixed to a peripheral portion 3a of the lid member 3. As shown in FIG. 2, the diaphragm 37 has a side portion 37b at its edge portion that, initially, stands up vertically towards the lid member 3. The lid member 3 is placed within this side portion 37b, and then, by a swaging process, the side portion 37b is bent over on the peripheral portion 3a of the lid member 3, and clamps the lid member 3 in position.

The lid member 3 is made from a ferrous metal such as carbon steel or the like, and a plated layer of nickel or the like is deposited over its entire exterior surface and over its entire interior surface. This lid member 3 has a hat shape, and includes a disk shaped peripheral flange part 3a contacted to the diaphragm 37 and a head portion 3b that projects upwards from this peripheral part 3a. An aperture 3c is formed in the head portion 3b. This aperture 3c is for allowing gas that has been generated internally to the cell to vent and escape to the exterior, when the pressure of this gas internal to the cell has ruptured the diaphragm 37 as described above.

It should be understood that, if the lid member is made from a ferrous metal, then, when joining this cylindrical secondary cell in series with another cylindrical secondary cell of the same type that is also made from a ferrous metal, it is possible to join them together by spot welding.

The lid member 3, the diaphragm 37, the insulation ring 34, and the connection plate 35 constitute an integrated lid unit 30. A method for assembling this lid unit 30 will now be described.

First, the lid member 3 is fixed to the diaphragm 37. This fixing together of the diaphragm 37 and the lid member 3 is performed by swaging or the like. Since initially the side wall 37b of the diaphragm 37 is formed as vertical, as shown in FIG. 2, accordingly the peripheral part 3a of the lid member 3 can be fitted in within the side wall 37b of the diaphragm 37. And then the side wall 37 of the diaphragm 37 is deformed by being pressed inwards or the like, so that it is pressed into contact with and covers the upper and lower surfaces of the peripheral part of the lid member 3 as well as its external circumferential edge.

On the other hand, the connection plate 35 is fitted into the opening 34a of the insulation ring 34. Next, the projecting portion 35a of the connection plate 35 is welded to the bottom surface of the diaphragm 37 to which the lid member 3 is fixed, in the state in which the insulation ring 34 is sandwiched between them. As the method of welding in this case, resistance welding or friction stir welding may be used. Due to this, the connection plate 35 is welded to the diaphragm 37 to which the lid member 3 is fixed, with the insulation ring 34 interposed between them, and these components are all integrated together into the single lid unit 30.

As described above, the connection plate 35 of the lid unit 30 is connected to the positive electrode current collecting member 27 by the connection member 33. Accordingly, the lid member 3 is electrically connected to the positive electrode current collecting member 27. In this manner, the lid member 3 to which the positive electrode current collecting member 27 is connected operates as a positive output terminal, so that it becomes possible to output electrical power accumulated in the electrode group 10, because the cell container operates as the negative output terminal while the lid member 3 operates as the positive output terminal.

A seal member 43, normally termed a gasket, is provided for covering the peripheral part of the side portion 37b of the diaphragm 37. This seal member 43 is made from rubber, although this is not intended to be limitative; an example of one possible material that may be employed is ethylene propylene copolymer (EPDM). Furthermore, for example, the cell container 2 may be made of carbon steel of thickness 0.5 mm and its external diameter may be 40 mm, while the thickness of the seal member 43 may be around 1.0 mm.

Initially, as shown in FIG. 2, the seal member 43 has a shape that includes an annular base portion 43a, an external peripheral wall portion 43b that is formed on the outer circumferential edge of this annular base portion 43a so as to stand almost vertically upwards, and a cylinder portion 43c that is formed so as to drop almost vertically downwards from the inner circumferential edge of the base portion 43a.

And, while the details thereof will be described hereinafter, swage processing is performed by pressing and so on, so as to bend down the upper edge portion of the cell container 2 along with the external peripheral wall portion of the seal member 43, and thereby the diaphragm 37 and the lid member 3 are pressed into contact along the axial direction by the base portion 43a and the external peripheral wall portion 43b of the seal member 43. Due to this, the lid unit 30 in which the lid member 3, the diaphragm 37, the insulation ring 34, and the connection plate 35 are integrated together is fixed to the cell container 2 with the interposition of the seal member 43.

A predetermined amount of a non-aqueous electrolyte is injected into the interior of the cell container 2. A solution of a lithium salt dissolved in a carbonate series solvent is a preferred example of such a non-aqueous electrolyte that may be used. Examples that may be cited of lithium salts are lithium hexafluorophosphate (LiPF₆), lithium tetrafluoroborate (LiBF₄), and so on. Furthermore, examples that may be cited of carbonate series solvents are ethylene carbonate (EC), dimethyl carbonate (DMC), propylene carbonate (PC), methyl-ethyl carbonate (MEC), mixtures of two or more solvents selected from the above, and so on.

Construction of the Cell Container

Next, the construction of the cell container 2 will be explained in detail.

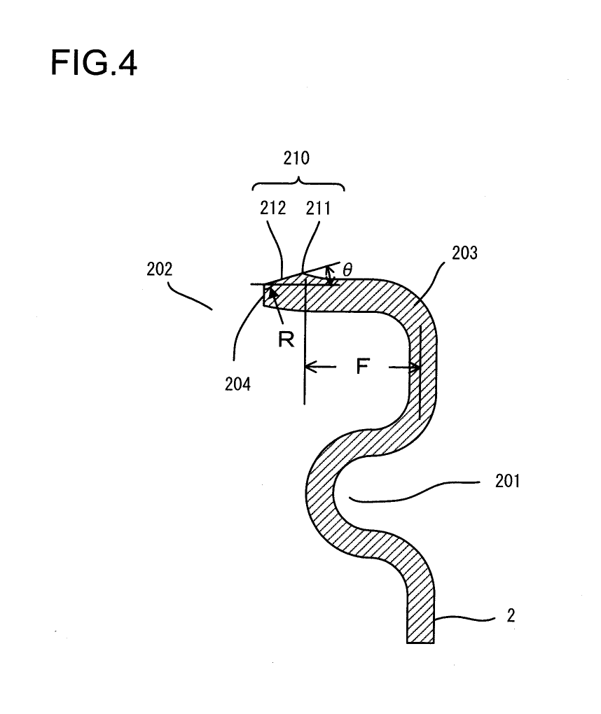

FIG. 4 is an enlarged sectional view of a portion A of the cell container shown in FIG. 1 and surrounded by the double dotted broken line in that figure.

The cell container 2 is made from ferrous metal plate, aluminum plate, stainless steel plate, or the like, and has a thickness of 0.4 mm to 0.8 mm. A groove 201 whose cross section is almost U-shaped is formed around the cell container 2 near the opening 202, so as to project inward. The cell container 2 has a curved portion 203 above the groove 201, and, at this curved portion 203, the material of the cell container 2 is bent around towards the axis of the cell container 2 in a horizontal direction, or, to put it in another manner, through almost a right angle. A protruding portion 210 is formed between this curved portion 203 and the edge portion 204 of the cell container 2 that faces its aperture 202, i.e. its inner edge around the aperture 202, and this protruding portion 210 protrudes somewhat upwards in FIG. 4, or, to put it in another manner, towards the outside of the cell container 2. This protruding portion 210 includes an edged summit portion 211 on the outer surface of the cell container 2 that is formed in an annular ring around the edge portion 204, and a sloping portion 212 that slopes from the edge portion 204 towards the summit portion 211 so that the plate thickness becomes greater.

The height of the summit portion 211 of the protruding portion 210 may be 0.05 mm or greater. Since, as described hereinafter, the dimension from the edge portion 204 to the summit portion 211 is approximately equal to the plate thickness, accordingly, if the plate thickness is 0.5 mm, the angle of slope θ of the sloping portion 212 with respect to the horizontal is approximately 5°. A plated layer of nickel or the like is formed over the entire outer surface of the cell container 2 including the protruding portion 210, and also over its entire inner surface.

In this embodiment of the present invention, the protruding portion 210 having the sloping portion 212 that slopes from the edge portion 204 in the direction to make the plate thickness greater is formed in the vicinity of the edge portion 204 of the cell container 2, and its corner portion R with the edge portion 204 forms an obtuse angle. Due to this, when the plated layer is being deposited by electroplating, the intensity of the electric field at this corner portion R is somewhat reduced as compared with a prior art cell container in which this corner portion R with the edge portion 204 has been formed in a right angle, so that, to this extent, it is possible to keep down the thickness of the plated layer formed at the corner portion R. Since the thicker the plated layer is, the more easily does detachment of the plated layer occur, accordingly with this structure, it becomes possible to reduce the frequency of occurrence of detachment of the plated layer.

Moreover, with this embodiment of the present invention, the protruding portion 210 has the summit portion 211 that is formed in an annular ring around the external circumference of the outer surface of the cell container 2. Due to this, when bending the cell container by pressure, the pressing surface of the press die contacts against this summit portion 211. Because the summit portion 211 is formed as a circular ring, i.e. the protruding portion has a shape of a circular annulus in planar view, the pressing surface of the press die contacts uniformly against it. This is very important for ensuring that the bending moment that acts upon the curved portion 203 is uniform, and for ensuring that the dimension F from the bending fulcrum to the point of operation is uniform over the entire circumference of the cell container 2, in order to ensure that the angle through which the cell container 2 is bent after the processing is uniform over the entire circumference. Since in this embodiment of the present invention the press die is uniformly contacted against the summit portion 211 of the protruding portion 210 as described above, accordingly the dimension F is uniform around the entire circumference. Due to this, the pressure that is applied operates uniformly, so that the shape of the curved portion 203 becomes uniform. This fact means that variations in the internal stresses that operate upon the plated layer after it has been deposited upon the cell container 2 are reduced, and, due to this, a further beneficial operational effect in terms of suppressing detachment of the plated layer is provided.

Since this construction operates as described above, there is no particular upper limit upon the height of the summit portion 211 from the point of view of the beneficial effect that it can produce. However, there is a limit from the point of view of ease of the processing to be performed, and this will be described hereinafter.

Method of Manufacturing the Cell Container

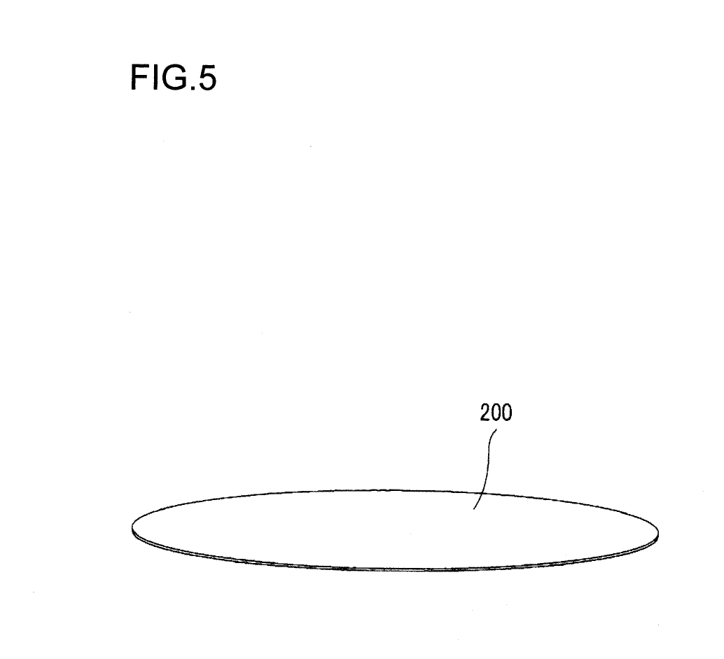

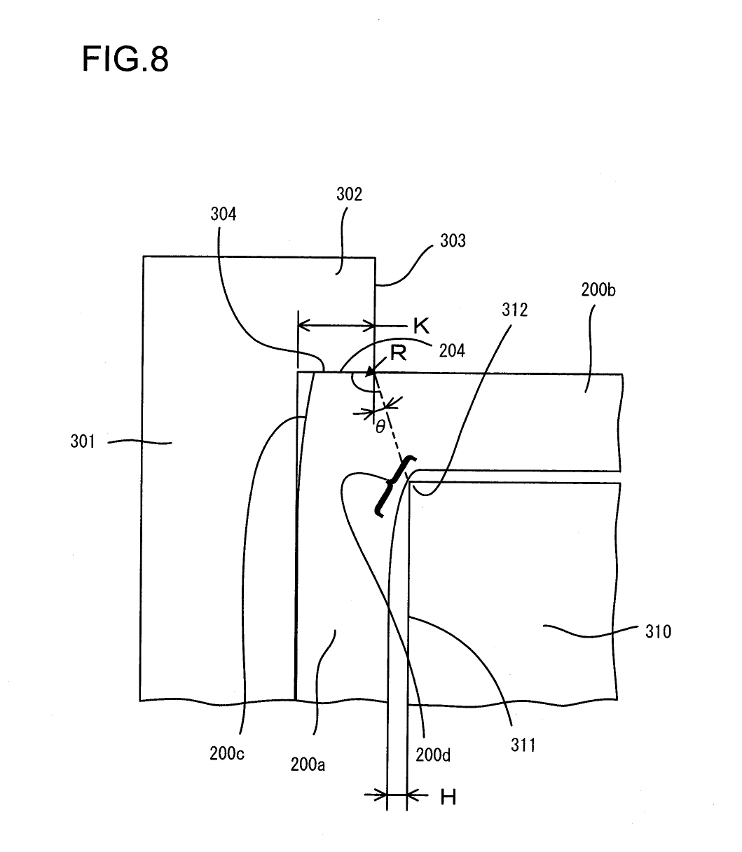

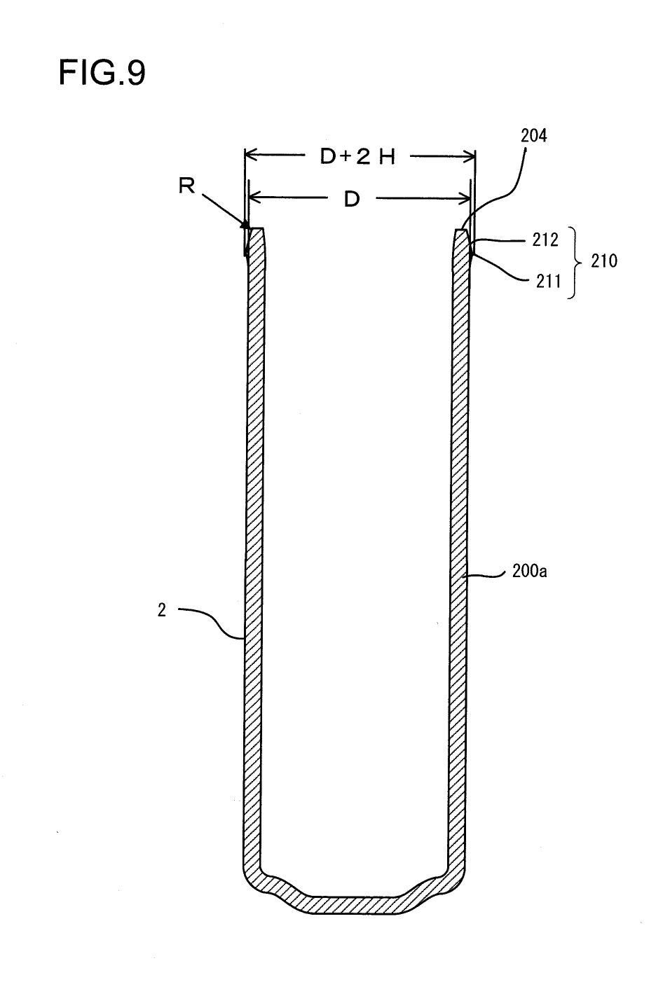

The method of manufacturing the cell container 2 will now be explained with reference to the perspective views of FIGS. 5 through 7 that show the process of manufacturing certain components of the cell container 2, and with reference to the enlarged sectional view of FIG. 8 that shows an important portion thereof, and the sectional view of the entire cell container 2 shown in FIG. 9.

First a metallic plate 200 is prepared in a circular shape and having a uniform thickness, as shown in FIG. 5. A ferrous metal, aluminum, stainless steel or the like may be suggested as materials for this metallic plate 200. Furthermore, the thickness of the metallic plate 200 is typically from 0.4 mm to 0.8 mm. If a plate of aluminum or the like is used, it may be thicker, since the strength of aluminum is relatively low.

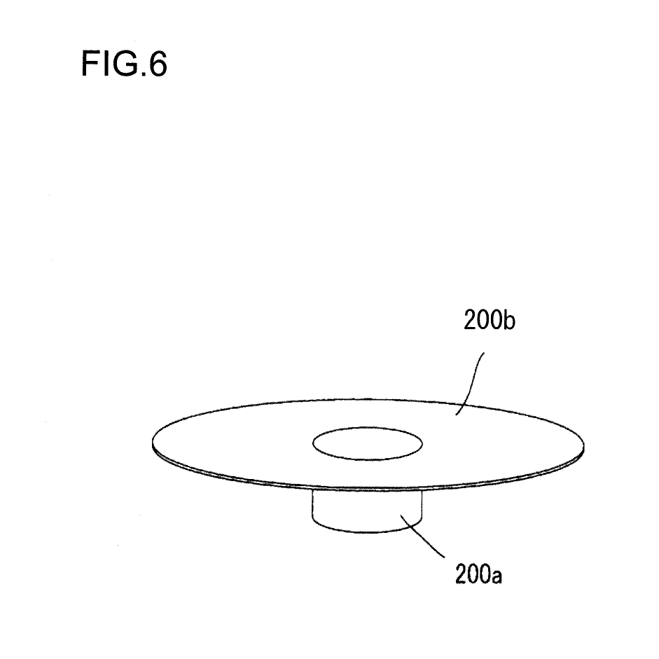

The metallic plate 200 is subjected to a drawing process, and thereby, as shown in FIG. 6, a central shallow cylindrical portion 200a is formed, with a flange portion 200b of a predetermined width remaining as formed around the periphery of the metallic plate 200. This drawing process for forming the cylindrical portion 200a is performed over a number of separate drawing steps, since it is difficult to manufacture the entire cylindrical portion 200a in a single step to have the same depth as the desired cell container 2 that is to be the finished product.

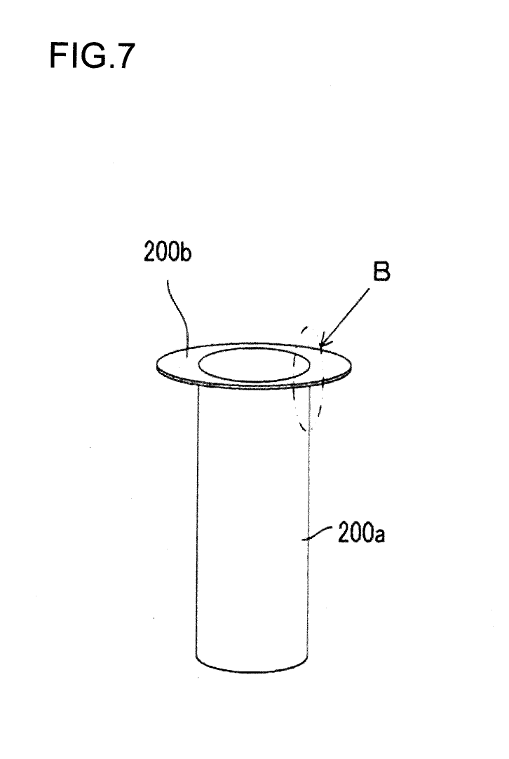

By repeatedly performing this drawing process, as shown in FIG. 7, the formation of the cylindrical portion 200a is completed at the time point that it has the same depth as the desired cell container 2 that is to be the finished product. In this state, the metallic plate 200 has been formed into the cylindrical portion 200a, and the flange portion 200b remains around the external circumference of the upper end of the cylindrical portion 200a. In other words, at the start of the process, a metallic plate 200 was used that was appropriately dimensioned for it to be capable of being formed as described above into the cylindrical portion 200a that has the same depth as the cylindrical portion of the desired cell container 2 that is to be the finished product, and the flange portion 200b that remains around the external circumference of the upper end of the cylindrical portion 200a.

FIG. 8 is an enlarged sectional view showing a situation in which the flange portion 200b of the metallic plate 200 in which the cylindrical portion 200a has been formed is being cut away, and is an enlarged sectional view of the portion B surrounded in FIG. 7 by the double dotted broken line.

As described above, the flange portion 200b is formed upon the external periphery of the top end of the cylindrical portion 200a of the metallic plate 200. On this cylindrical portion 200a, the inner surface of the portion that continues into the flange portion 200b is formed into a curved surface 200c during the drawing process. This curved surface 200c is curved in the direction for the internal diameter of the cylindrical portion 200a gradually to become greater upwards, in other words towards the flange portion 200b.

The curved surface 200c at the inner circumference of the cylindrical portion 200a is closely contacted against the side surface of an upper die 301, and moreover the upper surface of the flange portion 200b is closely contacted against the lower surface 304 of the upper portion 302 of this upper die 301. The upper die 301 is shaped so that, at this time, the circumferential side surface 303 of its upper portion 302 is positioned at an intermediate point along the thickness of the cylindrical portion 200a.

Furthermore, a lower die 310 is positioned at the outer circumferential surface side of the cylindrical portion 200a where it continues into the flange portion 200b. During the drawing process, this outer circumferential surface side of the cylindrical portion 200a is also formed into a curved surface 200d. This curved surface 200d is curved in the direction for the external diameter of the cylindrical portion 200a gradually to become greater upwards, in other words towards the flange portion 200b. The lower die 310 is arranged so that a predetermined gap H is formed between it and the external circumferential side of the cylindrical portion 200a. This gap H is dimensioned so as to have the height desired for the summit portion 211 of the protruding portion 210 described above, and may be 0.05 mm or greater. In this case, as shown in FIG. 8, it is arranged for the corner portion 312 of the lower die 301 to contact against the curved surface 200d on the outer circumferential surface side of the cylindrical portion 200a.

From the state shown in FIG. 8, by driving the lower die 310 in the upwards direction, the metallic plate 200 is cut in an almost linear manner as shown by the double dotted broken line, and the flange portion 200b is separated off and discarded, so that the cell container 2 is formed. A sectional view of the cell container that has been made in this manner is shown in FIG. 9.

The cell container 2 in its state shown in FIG. 9 differs from the completely formed cell container 2 shown in FIG. 1, by the feature that the protruding portion 210 has not yet been bent through a right angle with respect to the axial direction of the cell container 2, and moreover by the feature that the groove 201 has not yet been formed. However, the diameter of the cylinder portion and the shape of the bottom portion are the same as desired for the finished product. It should be understood that in FIG. 9, in order to show the shape of the protruding portion 210 and so on more clearly, the plate thickness is shown as being greater, as compared to the cell container 2 shown in FIG. 1.

If reference is made to FIGS. 8 and 9, it can be determined that the site on the curved surface 200d of the outer circumferential surface side of the cylindrical portion 200a where the corner portion 312 of the lower die 310 comes into contact therewith becomes the summit portion 211, and that the surface shown in FIG. 8 by the double dotted broken line becomes the sloping portion 212 of the protruding portion 210. Moreover, the angle θ that the straight line (i.e. the double dotted broken line) joining the contacting portion of the circumferential side surface 303 of the upper die 301 upon the flange portion 200b and the contacting portion of the corner portion 312 of the lower die 310 upon the curved surface 200d of the outer circumferential surface side of the cylindrical portion 200a makes with respect to the axial direction of the cell container 2 becomes the angle of slope θ of the sloping portion 212 of the protruding portion 210.

Accordingly the cell container 2 shown in FIG. 9 has the cylindrical portion 200a of external diameter D and the protruding portion 210 that is formed in a circular annulus upon the outer surface of the upper portion of this cylindrical portion 200a, and has the summit portion 211 whose external diameter is given by (D+2H). Moreover, the thickness of the edge portion 204 is made to be slightly less than the thickness of the original plate.

Referring to FIG. 8, on the upper die 301, the engagement dimension K between its surface where it contacts against the inner circumferential surface of the cylindrical portion 200a and its circumferential side surface 303 determines the thickness of the edge portion 204 of the cell container 2. Since the angle of the corner portion R at the edge portion 204 is greater than a right angle by just the angle of slope θ, and since this is the smaller, the smaller is this engagement dimension K, accordingly it is desirable for this engagement dimension K to be small, from the point of view of reduction of the electric field strength of the corner portion R during the plating process. However, if the engagement dimension K becomes too small, then the edge portion 204 may be damaged, and cutting of the flange portion 200b may become difficult. Due to this type of factor, it is necessary for the engagement dimension K to be half or more of the plate thickness of the cylindrical portion 200a.

Method of Manufacturing the Secondary Cell

In the following, a method will be explained of manufacturing the shown cylindrical secondary cell that is an embodiment of the present invention.

Manufacturing the Electrode Group

First, the electrode group 10 is manufactured. A positive electrode 11 is made by forming a positive electrode mixture layer 11b and a positive electrode mixture untreated portion 11c on both sides of a positive electrode sheet 11a, and a large number of positive leads 16 are formed integrally with the positive electrode sheet 11a. Moreover, a negative electrode 12 is made by forming a negative electrode mixture layer 12b and a negative electrode mixture untreated portion 12c on both sides of a negative electrode sheet 12a, and a large number of negative leads 17 are formed integrally with the negative electrode sheet 12a.

Next, the innermost edge portions of a first separator 13 and a second separator 14, in other words the starting edge portions of these separators where winding is to commence, are welded to a winding core 15. Next, the first separator 13 and the second separator 14 are wound up by one turn through several turns upon the winding core 15, the starting edge portion of the negative electrode 12 is inserted between the second separator 14 and the first separator 13 upon the winding core 15, and the winding core 15 is rotated through a predetermined angle so as further to wind up the second separator 14, the first separator 13, and the negative electrode 12 somewhat. And next, the starting edge portion of the positive electrode 11 is inserted between the first separator 13 and the second separator 14. And in this state the winding core is rotated through a predetermined number of turns, whereby the manufacture of this electrode group 10 is completed.

Manufacturing the Generating Unit

Next, a negative electrode current collecting member 21 is fitted to the lower portion of the winding core 15 of this electrode group 10 that has been manufactured by the method described above.

This fitting of the negative electrode current collecting member 21 is implemented by fitting the stepped portion 15b provided on the lower end portion of the winding core 15 into the aperture 21b that is formed in the negative electrode current collecting member 21. Next, the negative leads 17 distributed equally around the entire external circumference of the external circumferential cylinder portion 21c of the negative electrode current collecting member 21 are attached firmly there, and then the pressure member 22 is fitted over the external circumference of the negative electrode current collecting member 21, i.e. over the negative leads 17. And the negative electrode current collecting member 21, the negative leads 17, and the pressure member 22 are then welded together by ultrasonic welding or the like. And next, the negative electrode power lead 23 is welded to the negative electrode current collecting member 21, so as to straddle the lower end surface of the winding core 15 and the negative electrode current collecting member 21.

Next, one end portion of the connection member 33 is welded to the base portion 27a of the positive electrode current collecting member 27, for example by ultrasonic welding. And next, the lower cylindrical portion 27b of the positive electrode current collecting member 27, to which the connection member 33 has been welded, is fitted into the stepped portion 15a that is provided in the upper end of the winding core 15. In this state, the positive leads 16 distributed equally around the entire external circumference of the upper cylindrical portion 27c of the positive electrode current collecting member 27 are attached firmly there, and then the pressure member 28 is fitted over the external circumference of the positive electrode current collecting member 27, i.e. over the positive leads 16. And the positive electrode current collecting member 27, the positive leads 16, and the pressure member 28 are then welded together by ultrasonic welding or the like. By doing this, the generating unit 20 shown in FIG. 2 is manufactured.

Manufacturing the Cell Container

On the other hand, a cell container 2 is manufactured as explained in connection with FIGS. 5 through 9. And electroplating is performed over the entire outer surface and over the entire inner surface of this cell container 2. Since the corner portion R of the edge portion 204 of the cell container 2 is formed as an obtuse angle that is larger than a right angle by just the angle of slope θ of the sloping portion 212, accordingly the thickness of the plated layer in this region is somewhat thinner than it would be if the corner portion R were to be formed as a right angle.

Loading the Generating Unit 20 into the Cell Container 2

Then, the generating unit 20 is loaded into the cell container 2 shown in FIG. 9.

Connecting the Negative Electrode

With the generating unit 20 loaded into the cell container 2, the negative electrode power lead 22 is welded to the bottom of the cell container 2 by resistance welding or the like. Although this process is not shown in the figure, at this time, an electrode rod is inserted through the opening 27e of the positive electrode current collecting member 27, is passed down the hollow portion of the winding core 15, and is pressed against the negative electrode power lead 23 so as to push it against the bottom portion of the cell container 2, so that resistance welding can be performed.

Next, a portion of the upper end of the cell container 2 is processed by being pushed radially inward, so that the cell container outer surface is formed into the groove 201 that is almost U-shaped. This groove 201 on the cell container 2 is formed so as to be positioned at the upper end portion of the generating unit 20, or, to put it in another manner, in the vicinity of the upper end of the positive electrode current collecting member 27.

Injection of the Electrolyte

Next, a predetermined amount of a suitable non-aqueous electrolyte is injected into the interior of the cell container 2 in which the generating unit 20 is contained. For this non-aqueous electrolyte, for example, as described above, a solution of a lithium salt dissolved in a carbonate series solvent may be used.

Manufacture of the Lid Unit

On the other hand, the lid unit 30 is manufactured separately from the process described above of assembling the cell container 2. As previously described, this lid unit 30 is made from the insulation ring 34, the connection plate 35 that is fitted into the aperture 34a of the insulation ring 34, the diaphragm 37 that is welded to the connection plate 35, and the lid member 3 that is fixed by swaging to the diaphragm 37. The method of manufacture of the lid unit 30 is as previously described.

Connecting the Positive Electrode

Now the electrode group 10 and the lid unit 30 are electrically connected together. First, the seal member 43 is mounted above the groove 201 of the cell container 2. In this state, as shown in FIG. 2, above the annular base portion 43a, the external peripheral wall portion 43b of the seal member 43 rises vertically from its base portion 43a. And one end portion of the lead plate 33 is joined by ultrasonic welding or the like to the upper surface of the base portion 27a of the positive electrode current collecting member 27 that is held within the cell container 2. Next, in this state, the other end portion of the lead plate 33 is joined to the above described lid unit 30.

This is done by doubling back the other end portion of the lead plate 33, holding this other end portion of the lead plate 33 that is doubled back in contact with the connection plate 35 of the lid unit 30 using a holding jig not shown in the figures, and, in this state, irradiating their contacting portions with a laser so as to perform laser welding. In this case, the joining surface of this other end portion of the lead plate 33 where it is joined to the connection plate 35 of the lid unit 30, and the joining surface of the one end portion of the lead plate 33 where it is joined to the base portion 27a of the positive electrode current collecting member 27, are on the same side of the lead plate 33.

Sealing the Cell

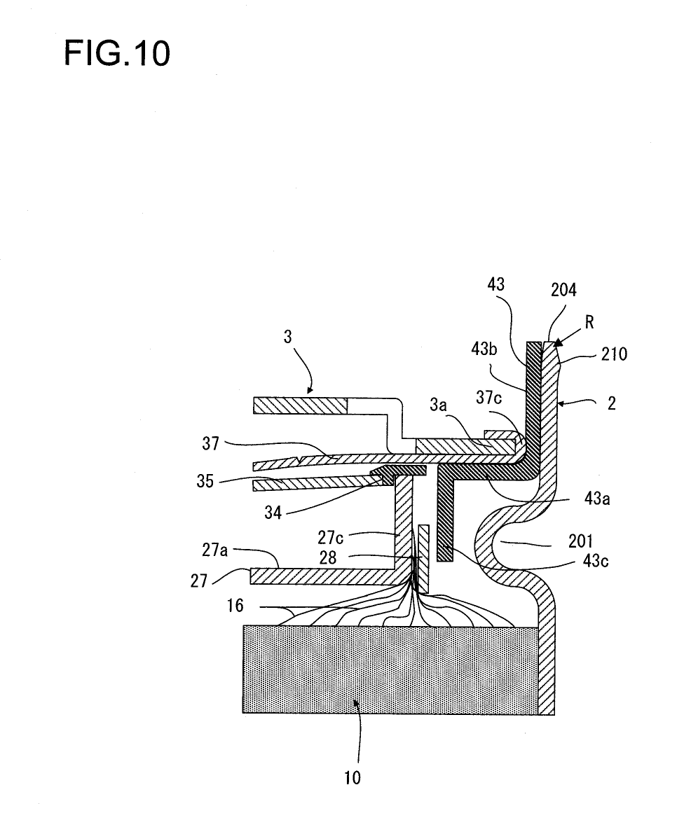

Next, the lid unit 30 is fitted into the top of the cell container 2, and, by performing swaging processing, the entire construction is sealed up from the exterior. FIGS. 10 through 12 are enlarged sectional views of the principal portions of this construction, for explanation of the method of swaging together the cell container 2 and the lid unit 30.

FIG. 10 shows the state in which the seal member 43 has been loaded into the upper end of the cell container 2 in which the U-shaped circumferential groove 201 has been formed, the one end portion of the lead plate 33 (refer to FIG. 1) has been welded to the positive electrode current collecting member 27, its other end portion has been welded to the connection plate 35 that is included in the lid unit 30 (this feature is not shown in this figure), and then the lid unit 30 has been loaded into the upper end of the cell container 2, upon and inside of the seal member 43.

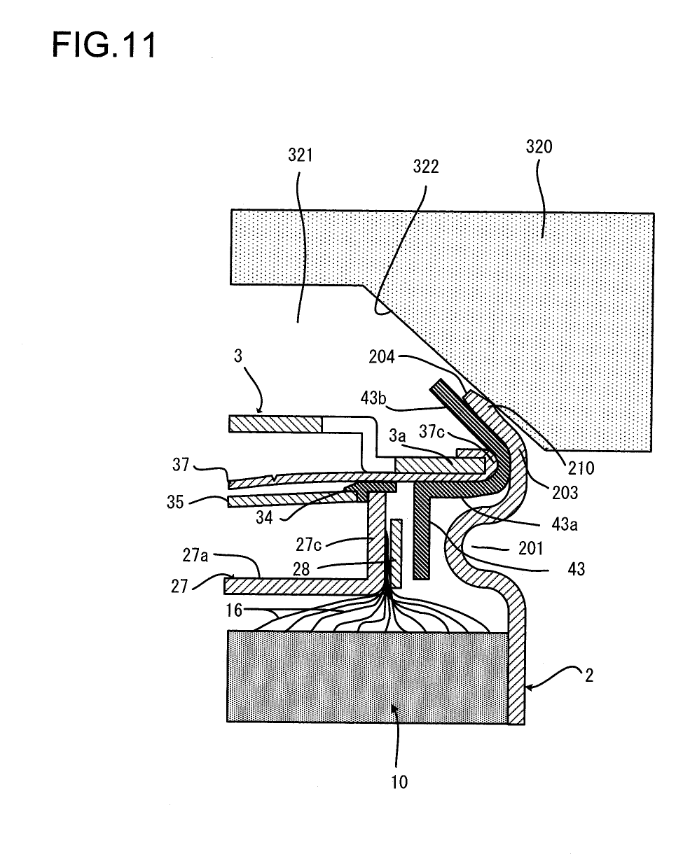

Next, as shown in FIG. 11, the edge portion 204 of the cell container 2 is bent radially inwards, using a press die 320 that is formed with a concave portion 321 having a conical trapezoidal shape. The cell container 2 is placed underneath the press die 320, the edge portion 204 of the cell container 2 is positioned so that it is located (in plan view) just within the outer peripheral edge of the concave portion 321 of the press die 320, and then the press die 320 is lowered. When this is done, the edge portion 204 of the cell container 2 is guided along the sloping surface 322 of the press die 320 and is bent inwards to form the curved portion 203. At this time, the external peripheral wall portion 43b of the seal member 43 is pushed by the edge portion 204 of the cell container 2 and the portions near it, so as to be pressed into contact with the periphery of the folded around portion 37c of the diaphragm 37 of the lid unit 30.

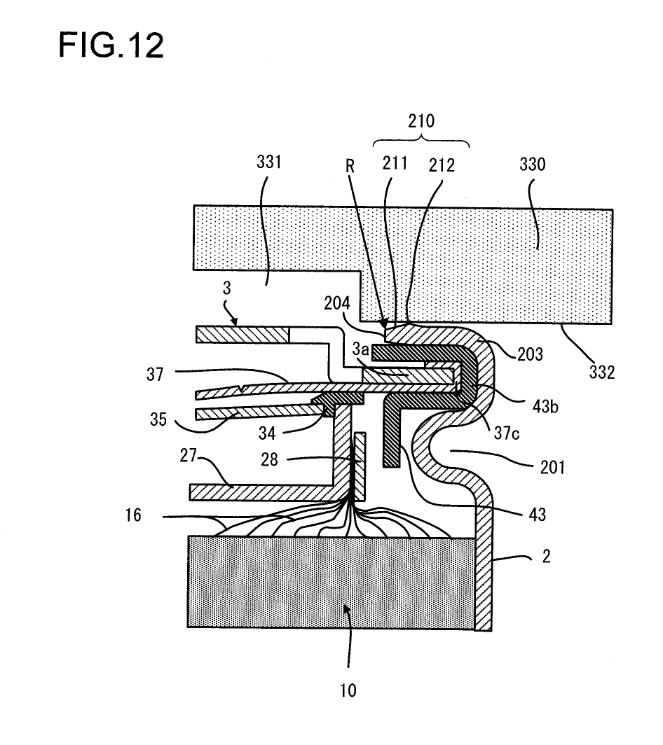

Next, as shown in FIG. 12, the curved portion 203 of the cell container 2 is further bent down, using a press die 330 that has a concave portion 331 so as to miss the lid member 3 and a flat surface 332. The cell container 2 is placed underneath the press die 330 so that the lid member 3 faces the concave portion 331, the position of the edge portion 204 of the cell container 2 is adjusted so that it corresponds to the flat surface 332, and then the press die 330 is lowered. And, due to the pressurization by the flat surface 332 of the press die 330, the edge portion 204 of the cell container 2 is bent downwards so as to extend in almost the horizontal direction; or, to put it in another manner, is bent so as to be almost at a right angle with respect to the axial direction of the cell container 2.

Along with the cell container 2 being bent at its curved portion 203, the seal member 43 is pushed inwards against the folded around portion 37c of the diaphragm 37 that is pressed into tight contact with the peripheral portion 3a of the lid member 3, and is compressed between the U-shaped groove 201 and the portions near the edge portion 204. Due to this, the lid unit 30 and the edge portion of the cell container 2 are swaged together with the interposition of the seal member 43, and are effectively sealed from the exterior. And, with this process, the manufacture of the lithium ion secondary cell shown in FIG. 1 is completed.

In this manner, with this sealing construction for a secondary cell according to the present invention, when performing this sealing processing by swaging, even if a large applied pressure operates upon the portions of the cell container 2 in the vicinity of the edge portion 204, it is still possible to reduce the frequency of detachment of the plated layer that is formed upon the corner R of the edge portion 204, since the thickness of this plated layer in this location is formed to be comparatively thin.

Furthermore, when bending the edge portion 204 of the cell container 2 through almost a right angle with respect to its axial direction, as shown in FIG. 12, the flat portion 332 of the press die 330 is contacted against the summit portion 211 of the protruding portion 210 of the cell container 2. Since this summit portion 211 of the cell container 2 is shaped as a circular annulus that extends all around the cell container 2, accordingly, even if the slope with respect to the horizontal in FIG. 12 of the sloping portion 212 of the edge portion 204 of the cell container 2 after processing varies somewhat, the point upon which the pressure applied by the press die 330 operates is always the summit portion 211 of the protruding portion 210. In other words, the dimension F in FIG. 4 remains always constant. Due to this, the shape through which the bent portion 203 of the cell container 2 is bent becomes uniform. This fact reduces variations of the internal stresses created in the plated layer, and accordingly the advantageous effect is obtained of suppressing detachment of the plated layer. Since, in this case, the bent portion 203 of the cell container 2 is bent uniformly, and therefore variation of its internal stresses is low, accordingly its strength also becomes high, and its reliability and durability against internal pressure generated in the battery are enhanced.

It should be understood that, in the embodiment described above, a case has been explained in which the lid unit 30 includes the lid member 3, the diaphragm 37, the insulation ring 34, and the connection plate 35. However, the structure of the lid unit 30 is not to be considered as being limited by this example; it could have some other structure. Moreover, the lid need not be an assembled unit; it could be a single unit, and may be an electrode terminal member that is endowed with the function of an electrode terminal.

While, in the embodiment described above, by way of example, a cylindrical lithium ion secondary cell has been explained, the present invention is not limited to a lithium cell; it could also be applied to some other type of cylindrical secondary cell, such as a nickel-hydrogen cell, a nickel-cadmium cell, or the like.

Moreover, within the scope of the concept of the present invention, the sealing construction for a secondary cell according to the present invention can be varied in many different ways; and thus, the present invention may be defined as a sealing construction for a secondary cell in which an electrode terminal member is disposed inside an opening of a cell container with the interposition of a seal member, with a circumferential portion of the cell container around its opening being bent inwards together with the seal member and the cell container and the electrode terminal member being swaged together, wherein: on the outer surface of the cell container, between the bent portion where the cell container is bent and the opening, an edged summit portion and a protruding portion having a sloping portion that ranges from an edge portion facing the opening of the cell container to the summit portion are formed in an annular shape around circumferential direction of the opening of the cell container.

The above described embodiments are examples, and various modifications can be made without departing from the scope of the invention.

What is claimed is:

1. A sealing construction for a secondary cell in which an electrode terminal member is disposed inside an opening of a cell container with interposition of a seal member, with a circumferential portion of the cell container around its opening being bent inwards together with the seal member and the cell container and the electrode terminal member being swaged together, wherein:
on outer surface of the cell container, between a bent portion where the cell container is bent and the opening, a protruding portion having an edged summit portion and having a sloping portion that ranges from an edge portion facing the opening of the cell container to the summit portion is formed in an annular shape around circumferential direction of the opening of the cell container.

2. A sealing construction for a secondary cell according to claim 1, wherein a plated layer is formed on outer surface and on inner surface of the cell container, including the protruding portion.

3. A sealing construction for a secondary cell according to claim 1, wherein the summit portion of the protruding portion of the cell container has a height of 0.05 mm or greater.

4. A sealing construction for a secondary cell according to claim 1, wherein the sloping portion of the protruding portion of the cell container has an angle of slope, rising from the direction orthogonal to the axis of the cell container, of 5° or greater with respect to the axis of the cell container.

5. A sealing construction for a secondary cell according to claim 1, wherein the cell container, including the protruding portion, is entirely made by sheet metal processing from a sheet of a metal selected from any one of ferrous metal, aluminum, or stainless steel.

6. A sealing construction for a secondary cell according to claim 1, wherein the secondary cell has a cylindrical shape, and the protruding portion has a shape of a circular annulus in planar view.

7. A sealing construction for a secondary cell according to claim 2, wherein the summit portion of the protruding portion of the cell container has a height of 0.05 mm or greater.

8. A sealing construction for a secondary cell according to claim 2, wherein the sloping portion of the protruding portion of the cell container has an angle of slope, rising from the direction orthogonal to the axis of the cell container, of 5° or greater with respect to the axis of the cell container.

9. A sealing construction for a secondary cell according to claim 2, wherein the cell container, including the protruding portion, is entirely made by sheet metal processing from a sheet of a metal selected from any one of ferrous metal, aluminum, or stainless steel.

10. A sealing construction for a secondary cell according to claim 2, wherein the secondary cell has a cylindrical shape, and the protruding portion has a shape of a circular annulus in planar view.

11. A secondary cell including the sealing construction for a secondary cell according to claim 1.
